(19) United States
(12) Patent Application Publication
(10) Pub. No.: US 2012/0011317 A1
(43) Pub. Date: Jan. 12, 2012

(54) DISK ARRAY APPARATUS AND DISK ARRAY CONTROL METHOD

(75) Inventors: Kazuhiko IKEUCHI, Kawasaki (JP); Hidejirou Daikokuya, Kawasaki (JP); Chikashi Maeda, Kawasaki (JP); Norihide Kubota, Kawasaki (JP)

(73) Assignee: FUJITSU LIMITED, Kawasaki (JP)

(21) Appl. No.: 13/095,017

(22) Filed: Apr. 27, 2011

(30) Foreign Application Priority Data
Jul. 6, 2010 (JP) 2010-154205

(51) Int. Cl. G06F 12/16

(52) U.S. Cl. 711/114; 711/E12.103

(57) ABSTRACT

When executing a sequential process on a volume of disks constituting RAID, a disk array apparatus determines whether a process other than the sequential process is executed in a predetermined period. The disk array apparatus specifies a disk type when the execution determining unit determines that no process other than the sequential process is executed in the predetermined period. The disk array apparatus then determines a multiplicity according to the disk type and executes the sequential process with the determined multiplicity.

### CROSS-REFERENCE TO RELATED APPLICATION

This application is based upon and claims the benefit of priority of the prior Japanese Patent Application No. 2010-154205, filed on Jul. 6, 2010, the entire contents of which are incorporated herein by reference.

### FIELD

The embodiments discussed herein are directed to a disk array apparatus and a disk array control method.

### BACKGROUND

Conventionally, in a disk array system, a format process and a rebuild process are executed as sequential processes in which data in disks constituting redundant arrays of inexpensive disks (RAID) are accessed sequentially.

The format process is a process executed, when a logical volume is created in the RAID in the disk array system, for ensuring the initial data of the data in the disks. The rebuild process is a process executed, when a disk failure occurs in the disk array system, for copying the data stored in the failed disk to a hot spare disk or to a replacement disk and then rebuilding the system in order to restore redundancy.

In such a disk array system, when a read command or a write command is issued with respect to wide non-contiguous areas on the disks, disk head seek occurs and thus the process performance is reduced compared to a case in which a command is issued with respect to a contiguous areas. Furthermore, when many commands are issued to contiguous areas, the commands are buffered in the disks and this accordingly reduces the performance.

As a result, in the disk array system, a sequential process, such as a format process or a rebuild process, is executed by a disk access with single multiplicity to a contiguous areas, not non-contiguous areas. In other words, by maintaining contiguousness of the command request area, the access performance in the sequential process is improved. For example, a technology is disclosed, as the disk access method with single multiplicity, in which, if there is no normal I/O (input/output), the process size of the format process or the rebuild process is increased compared with the case in which there is a normal I/O.

The conventional technology, however, has a problem in that a sequential process, such as a format process or a rebuild process, is sometimes not executed efficiently.

For example, with an increase in the disk capacity of currently used disks, the buffer, the number of platters in a disk, and the number of disk heads are increased. In addition, disks, such as an SSD (solid state disk), that does not need sequential access are used. Accordingly, in some cases, even in a sequential process, the processing speed for processing non-contiguous areas is faster than that for processing contiguous areas. Thus, there is case in which a current disk array system processing contiguous areas with single multiplicity is not the most efficient way to process the contiguous areas.
Patent Document: Japanese Laid-open Patent Publication No. 2007-094994

### SUMMARY

According to an aspect of an embodiment of the invention, a disk array apparatus includes an execution determining unit that, when a sequential process is executed on a volume of disks, determines whether a process other than the sequential process is executed in a predetermined period; a disk specifying unit that specifies a disk type of the disks when the execution determining unit determines that no process other than the sequential process is executed in the predetermined period; and a process execution unit that determines a multiplicity of the sequential process according to the disk type which is specified by the disk specifying unit, and executes the sequential process with the determined multiplicity.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram of a configuration of a disk array system including a disk array apparatus according to a first embodiment of the present invention;

FIG. 2 is a table of an example of information that is stored in an execution log DB;

FIG. 3 is a table of an example of information that is stored in a multiplication DB;

FIG. 4 is a diagram of an example of a data sequence of a volume to be processed;

FIG. 5 is a diagram of a sequential process with single multiplicity;

FIG. 6 is a diagram of a sequential process with triple multiplicity;

FIG. 7 is a diagram of a sequential process with triple multiplicity;

FIG. 8 is a diagram of an example of a change to single multiplicity from the state in FIG. 7;

FIG. 9 is a flowchart of a process flow upon execution of a sequential process;

FIG. 10 is a flowchart of a process flow during execution of the sequential process;

FIG. 11 is a block diagram of a configuration of a disk array system including a disk array apparatus according to a second embodiment of the present invention;

FIG. 12 is a diagram of an example of evaluating the performance with single multiplicity;

FIG. 13 is a diagram of an example of evaluating the performance with double multiplicity;

FIG. 14 is a diagram of an example evaluating the performance with triple multiplicity; and

FIG. 15 is a flowchart of a process flow upon execution of the sequential process according to the second embodiment.

### DESCRIPTION OF EMBODIMENTS

Preferred embodiments of the present invention will be explained with reference to accompanying drawings. The embodiments do not limit the invention.

[a] First Embodiment

Configuration of Disk Array Apparatus (First Embodiment)

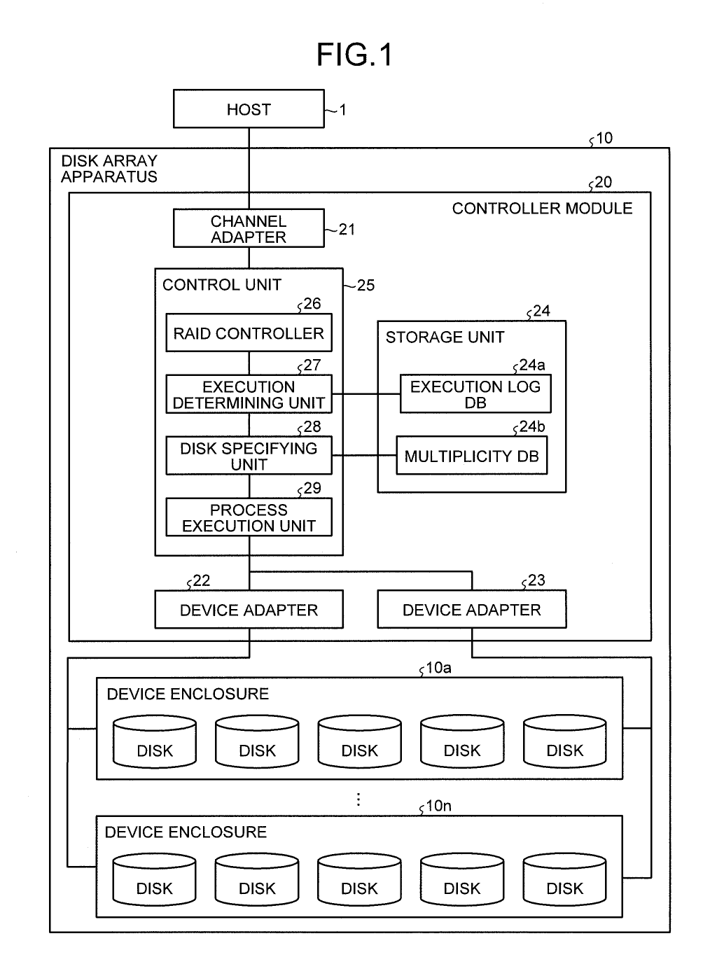

FIG. 1 is a block diagram of a configuration of a disk array system that includes a disk array apparatus according to a first embodiment of the present invention. As illustrated in FIG. 1, in the disk array system, a host 1 and a disk array apparatus 10 are connected so as to be communicable with each other using a fiber channel (FC) and an iSCSI (Internet Small Computer System Interface). The host 1 is a server device that stores data in the disk array apparatus 10 and reads data from the disk array apparatus 10.

FIG. 1 illustrates that one host and one disk array apparatus are connected to each other, but it is just an example and the present invention is not limited to this. For example, multiple hosts and multiple disk array apparatuses may be connected using an FC switch.

The disk array apparatus 10 includes device enclosures 10a to 10n and a controller module 20. Each of the device enclosures 10a to 10n is a casing that stores data of the host 1 and includes a plurality of disks constituting a RAID, such as RAID-0 or RAID-5. The disks are each, for example, an HDD (hard disk drive) or an SSD (solid state disk).

The controller module 20 is a processing unit that performs data control on the device enclosures 10a to 10n. The controller module 20 includes a channel adapter 21, a device adapter 22, a device adapter 23, a storage unit 24, and a controller 25.

The channel adapter 21 controls communications with the host 1 that is connected using an FC or an iSCSI. For example, the channel adapter 21 accepts a request for reading or writing data from the host 1 and transmits it to the controller 25. The channel adapter 21 receives data or a processing result from the controller 25 and transmits it to the host 1.

The device adapter 22 and the device adapter 23 are adapters that control communications between the device enclosures 10a to 10n and the controller module 20 and have redundant configurations. In other words, as long as any one of the device adapter 22 and the device adapter 23 operates normally, communications can be established between the device enclosures 10a to 10n and the controller module 20. The controller 25 described below writes data to the device enclosures 10a to 10n, or reads data from the device enclosures 10a to 10n, via the device adapter 22 and the device adapter 23.

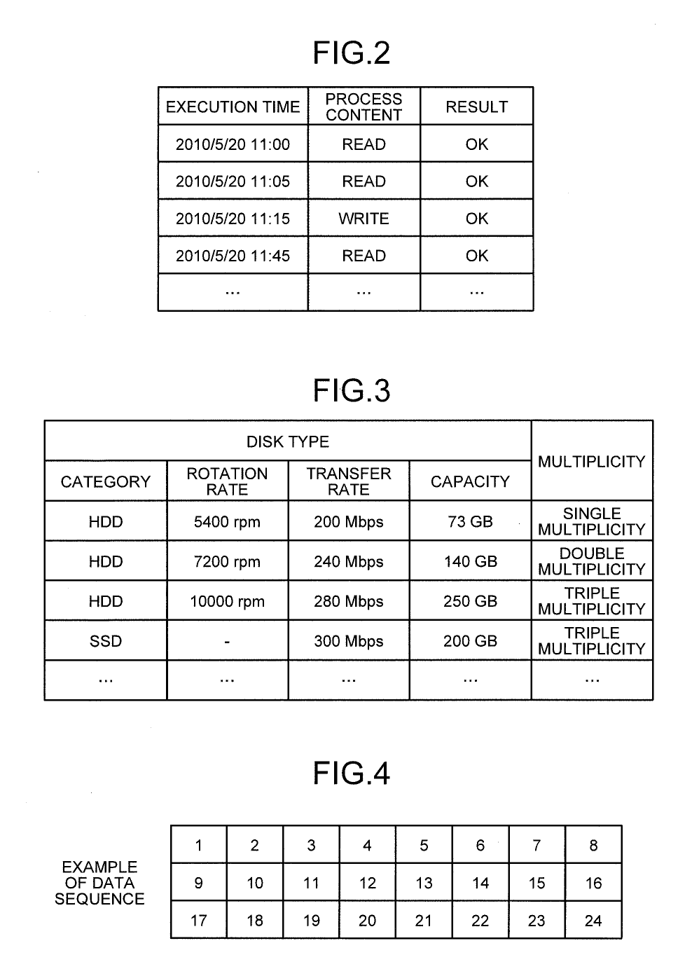

The storage unit 24 is a storage unit, such as a memory, that includes an execution log DB 24a and a multiplicity DB 24b. The execution log DB 24a stores the results of processes executed by the controller 25. Thus, information to be stored in the storage unit 24 is stored by the controller 25. FIG. 2 is a table of an example of the information that is stored in the execution log DB. As illustrated in FIG. 2, the execution log DB 24a stores, for example, “2010/05/20 11:00, READ, OK”, “2010/05/20 11:05, READ, OK”, “2010/05/20 11:15, WRITE, OK”, or “2010/05/20 11:45, READ, OK” as “EXECUTION TIME, PROCESS CONTENT, RESULT”.

The stored “EXECUTION TIME” represents the date at which the controller 25 executes a process, and the “PROCESS CONTENT” represents the content of a process, such as read, write, format, or rebuild, executed by the controller 25. The “RESULT” stored represents a result of a process by the controller 25. When the process is successful, “OK” is stored. When the process fails (error) “NG” is stored. In the case represented in FIG. 2, the “READ” executed at “2010/05/20 11:00” is successful and the “READ” executed at “2010/05/20 11:05” is successful. Also, the “WRITE” executed at “2010/05/20 11:15” is successful and the “WRITE” executed at “2010/05/20 11:45” is successful.

The multiplicity DB 24b stores multiplicities, with which a sequential process such as a format process or a rebuild process is executed, in association with categories of disks. FIG. 3 is a table of an example of the information stored in the multiplicity DB. As illustrated in FIG. 3, the multiplicity DB 24b stores “HDD, 5400 rpm, 200 Mbps, 73 GB, AND SINGLE” or “HDD, 7200 rpm, 240 Mbps, 140 GB, AND DOUBLE MULTIPLICITY” as “DISK TYPE (CATEGORY, ROTATION RATE, TRANSFER RATE, AND CAPACITY) AND MULTIPLICITY”. The multiplicity DB 24b also stores, for example, “HDD, 10000 rpm, 280 Mbps, 250 GB, AND TRIPLE MULTIPLICITY” and “SSD, -, 300 Mbps, 200 GB, AND TRIPLE MULTIPLICITY”.

The “CATEGORY” represents the disk category, the “ROTATION RATE” represents the rotation rate of a disk per minute, the “TRANSFER RATE” represents the data transfer rate of a disk, and the “CAPACITY” represents the storage capacity of a disk. The “MULTIPLICITY” represents the multiplicity with which a sequential process, such as a format process or a rebuild process, is executed. In other words, as represented in the case in FIG. 3, the sequential process is executed with “SINGLE MULTIPLICITY” on the HDD having the rotation rate “5400 rpm”, the transfer rate “200 Mbps”, and the capacity “73 GB”. Furthermore, a sequential process on the HDD having the rotation rate “7200 rpm”, the transfer rate “240 Mbps”, and the capacity “140 GB” is executed with “DOUBLE MULTIPLICITY”. Furthermore, a sequential process on the HDD having the rotation rate “10000 rpm”, the transfer rate “280 Mbps”, and the capacity “250 GB” is executed with “TRIPLE MULTIPLICITY”. Furthermore, a sequential process on an SSD having the transfer rate “300 Mbps” and the capacity “200 GB” is executed with “TRIPLE MULTIPLICITY” regardless of the rotation rate, transfer rate, and capacity.

The information illustrated in FIGS. 2 and 3 is just an example, and the present invention is not limited to this. The information can be arbitrarily set or changed. For example, the execution log DB 24a in FIG. 2 may further store information representing which disk executes a process on which volume and may not store “RESULT” in FIG. 2. The multiplicity DB 24b in FIG. 3 may further associate “CACHE CAPACITY”, which represents an area in which read data to be stored in the disk or data to be written is temporarily written. Furthermore, it may associate, for example, “SEEK TIME”, which represents an average time taken to move to a target track position on a disk. In other words, the information that determines multiplicity may be any information as long as it can specify disk performance or a disk. The information in FIG. 3 may be defined using not an “AND” condition but an “OR” condition.

The controller 25 is a processing unit that executes data write or data read. The controller 25 includes a RAID controller 26, an execution determining unit 27, a disk specifying unit 28, and a process execution unit 29. The RAID controller 26 performs parity operations, manages devices and disks, and installs and controls the RAID configuration consisting of the devices of the device enclosures 10a to 10n. In other words, the RAID controller 26 controls various processes, such as data read or data write, of the device enclosures 10a to 10n.

For example, upon receiving a data write request, which is transmitted from the host 1, from the channel adapter 21, the RAID controller 26 writes data in a predetermined volume of the device enclosures 10a to 10n. The RAID controller 26 then writes the process execution result in the execution log DB 24a. Upon receiving a data read request, which is transmitted from the host 1, from the channel adapter 21, the RAID controller 26 reads data from a predetermined volume of the device enclosures 10a to 10n and transmits the data to the host 1. The RAID controller 26 then writes the process execution result in the execution log DB 24a.

When executing a sequential process on a volume in the disks constituting the RAID, the execution determining unit 27 determines whether a process other than the sequential process has been executed in a predetermined period. For example, upon receiving a request to start a format process or a rebuild process from the host 1 or the manager, the execution determining unit 27 refers to the execution log DB 24a and determines whether a process other than the sequential process has been or will be executed in five minutes after and before the time at which the start request was received. When no process other than the sequential process is executed, the execution determining unit 27 outputs this fact to the disk specifying unit 28. When a process other than the sequential process is executed, the execution determining unit 27 outputs this fact to the process execution unit 29.

For example, when the time at which the start request is received is “2010/5/20 11:48” and when the execution determining unit 27 refers to FIG. 2 representing that “READ” is executed at “2010/5/20 11:45”, the execution determining unit 27 determines that a process other than the sequential process is executed.

When the execution determining unit 27 determines that no process other than the sequential process is executed in the predetermined period, the disk specifying unit 28 specifies the disk type. For example, upon receiving, from the execution determining unit 27, a notification that no process other than the sequential process is executed, the disk specifying unit 28 acquires various types of information from disks having a volume on which the format process or the rebuild process is to be executed.

For example, the disk specifying unit 28 acquires “CATEGORY, ROTATION RATE, TRANSFER RATE, AND CAPACITY” of the disks to be processed from information stored in a CM (cartridge memory) of a disk or disk information that is created by the manager. The disk specifying unit 28 outputs the acquired “CATEGORY, ROTATION RATE, TRANSFER RATE, AND CAPACITY” to the process execution unit 29. The information stored in the CM may be information stored by, for example, the manager or information stored by a disk manufacturer. The disk information created by the manager is a database that is created at a stage of configuring the disk array apparatus 10 and is stored in the storage unit 24.

The process execution unit 29 determines multiplicity according to the disk type that is specified by the disk specifying unit 28 and then executes the sequential process with the determined multiplicity. For example, the process execution unit 29 receives the “CATEGORY, ROTATION RATE, TRANSFER RATE, AND CAPACITY” from the disk specifying unit 28 and specifies a “MULTIPLICITY” corresponding to the received information from the multiplicity DB 24b. The process execution unit 29 executes the format process or the rebuild process with the specified “MULTIPLICITY” on the volume to be processed.

For example, it is assumed that the process execution unit 29 receives “HDD, 10000 rpm, 280 Mbps, AND 250 GB” as “CATEGORY, ROTATION RATE, TRANSFER RATE, AND CAPACITY” from the disk specifying unit 28. In this case, the process execution unit 29 determines “TRIPLE” multiplicity from the multiplicity DB 24b and executes the format process or the rebuild process with “TRIPLE MULTIPLICITY”.

Upon receiving a notification that a process other than the sequential process is executed in the predetermined period from the execution determining unit 27, the process execution unit 29 executes the sequential process with single multiplicity. If a process other than the sequential process is executed while the process execution unit 29 is executing the sequential process with the determined multiplicity, the process execution unit 29 executes the sequential process with single multiplicity. Specifically, if a normal I/O process, such as read or write, is executed while the process execution unit 29 is executing the sequential process with triple multiplicity, the process execution unit 29 changes the triple multiplicity to single multiplicity and then executes the sequential process.

Example of Execution by Process Execution Unit (First Embodiment)

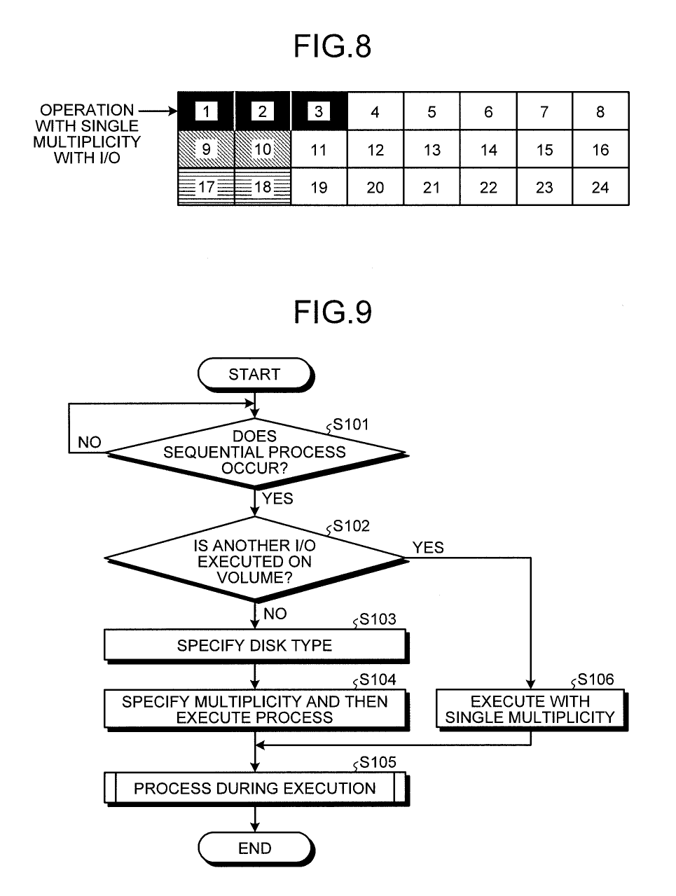

Specific examples of the process executed by the process execution unit 29 will be described below using FIGS. 4 to 8. FIG. 4 is a diagram of an example of a data sequence of a volume to be processed and FIG. 6 is a diagram of a sequential process with triple multiplicity. FIG. 7 is a diagram of a sequential process with triple multiplicity and FIG. 8 is a diagram of an example of a change to single multiplicity from the state in FIG. 7.

The numerals 1 to 24 in FIGS. 4 to 8 denote data and the order of sequential accesses. In other words, the sequential accesses to the volume are executed starting from 1. This illustration is just an example and the present invention is not limited to this.

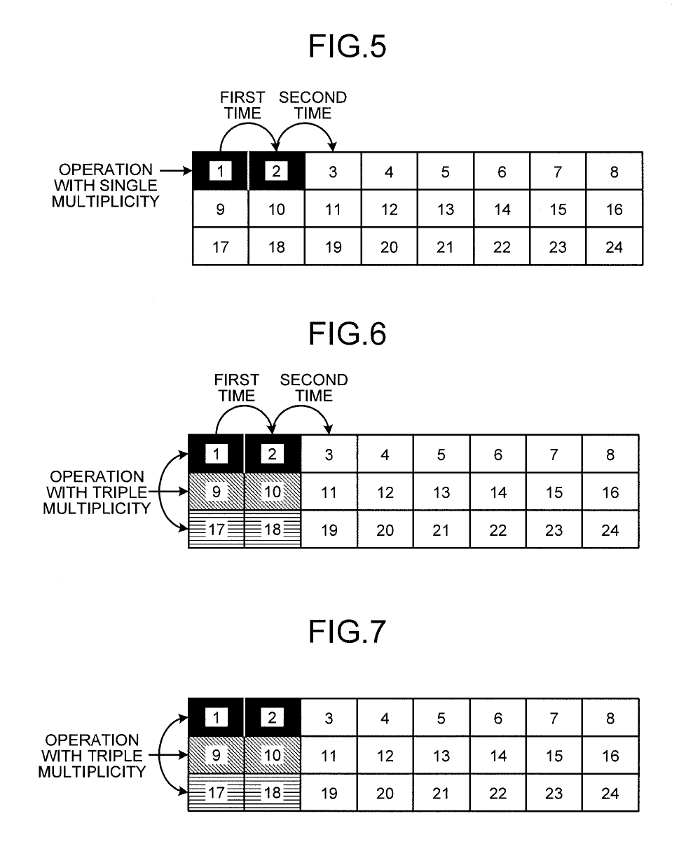

Accordingly, as illustrated in FIG. 4, when the process is executed with single multiplicity on the volume consisting of data 1 to 24, the process execution unit 29 sequentially executes the process from 1, as illustrated in FIG. 5. When the process is executed with triple multiplicity, as illustrated in FIG. 6, the process execution unit 29 sequentially executes the process on each of “1 to 8”, “9 to 16”, and “17 to 24”.

The process execution unit 29 executes process on “1 to 8”, “9 to 16”, and “17 to 24” sequentially with triple multiplicity, as illustrated in FIG. 7. It is assumed that the process executed on “2”, “10”, and “18” is completed, and it is assumed that, in this state, a normal I/O process occurs. In this case, the process execution unit 29 stops the process on “11” and the following data and “19” and the following data and executes the process on only “3” and the following data. In other words, the process execution unit 29 changes the triple multiplicity to single multiplicity and then executes the process. The process execution unit 29 stores the data on which the process is completed as, for example, “9”, “10”, “17”, “18” completed, in, for example, the storage unit. As a result, the process execution unit 29 can know for which data the process is completed. Thus, even when the triple multiplicity is changed to single multiplicity, the process execution unit 29 can be prevented from reprocessing the data on which the process is already completed.

Process Flow (First Embodiment)

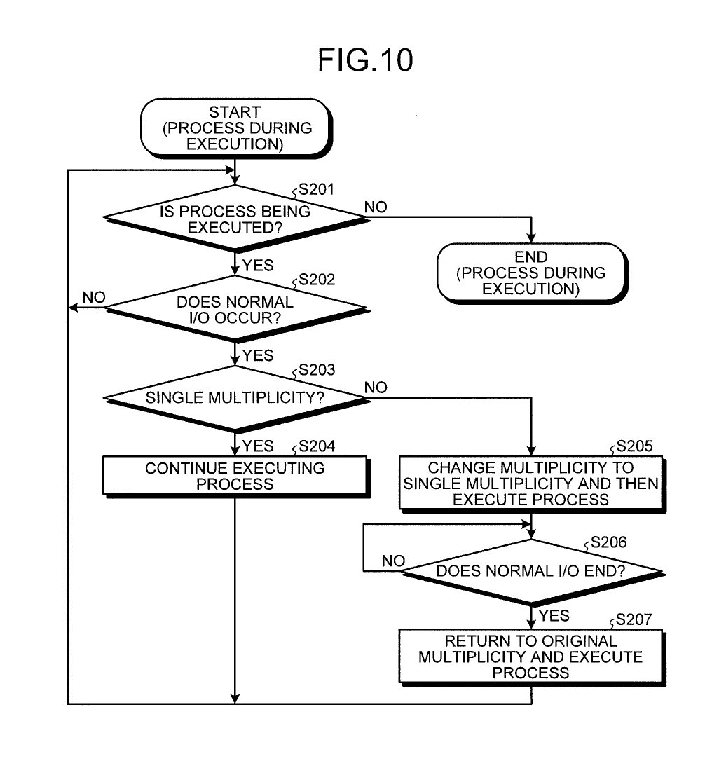

The process flow of the disk array apparatus according to the first embodiment will be described using FIGS. 9 and 10. Here, the process flow when executing the sequential process will be described using FIG. 9 and the process flow upon execution of the sequential process will be described using FIG. 10.

Process Flow Upon Execution of Sequential Process

FIG. 9 is a flowchart of a process flow upon execution of the sequential process. As illustrated in FIG. 9, the execution determining unit 27 of the disk array apparatus 10 accepts an instruction for starting a sequential process on a volume in the disks constituting the RAID (YES at step S101). The execution determining unit 27 then refers to the execution log DB 24a and determines whether a process other than the sequential process is executed on the volume to be processed in the predetermined period (step S102).

When the execution determining unit 27 determines that no process other than the sequential process is executed in the predetermined period (NO at step S102), the disk specifying unit 28 specifies the disk type (step S103). Sequentially, the process execution unit 29 determines the multiplicity corresponding to the disk type, which is specified by the disk specifying unit 28, from the multiplicity DB 24b and executes the sequential process with the determined multiplicity (step S104). The disk array apparatus 10 then executes the process flow during execution of the sequential process in FIG. 10 (step S105).

In contrast, upon receiving a notification that a process other than the sequential process is executed in the predetermined period (YES at step S102), the process execution unit 29 executes the sequential process with single multiplicity (step S106). The disk array apparatus 10 then executes the process flow during execution of the sequential process in FIG. 10 (step S105).

Process Flow During Execution of Sequential Process

FIG. 10 is a flowchart of the process flow during execution of the sequential process. The process corresponds to step S105 in FIG. 9. As illustrated in FIG. 10, the process execution unit 29 of the disk array apparatus 10 keeps monitoring whether the sequential process is in execution (step S201).

When the sequential process is in execution (YES at step S201), the process execution unit 29 determines whether a normal I/O, such as read or write, occurs in the volume on which the sequential process is being executed (step S202).

Thereafter, when the process execution unit 29 detects that a normal I/O occurs in the volume on which the sequential process is being executed (YES at step S202), the process execution unit 29 determines whether the sequential process in execution is being executed with single multiplicity (step S203).

When the process execution unit 29 determines that the sequential process is being executed with single multiplicity (YES at step S203), the process execution unit 29 continues executing the sequential process being executed with single multiplicity (step S204). Thereafter, step S201 and the following steps are repeated.

In contrast, when the process execution unit 29 determines that the sequential process in execution is not being executed with single multiplicity (NO at step S203), the process execution unit 29 changes the multiplicity to single multiplicity and then continues executing the sequential process in execution (step S205). Thereafter, when the normal I/O in the volume on which the sequential process is being executed ends (YES at step S206), the process execution unit 29 returns the original multiplicity before the multiplicity was changed to single multiplicity and then executes the sequential process (step S207). Thereafter, step S201 and the following steps are repeated.

At step S201, when the sequential process is not in execution, i.e., when the sequential process ends (NO at step S201), the process execution unit 29 ends the process.

Effects of First Embodiment

According to the first embodiment, by determining whether another I/O has occurred in a volume to which a format process or a rebuild process is to be executed, the multiplicity can be actively changed. In other words, the process can be executed with a multiplicity taking in account of the occurrence of I/O or the load of the disks and thus the sequential process can be executed efficiently. Even if there are various types of disks, according to each type of disk, a format process or a rebuild process can be executed with a multiplicity in which the maximum performance can be achieved. In addition, even when the rate at which a format process or a rebuild process is executed is increased, the influence on other I/O processes can be minimized, i.e., only the process method is switched.

[b] Second Embodiment

The disk array apparatus disclosed in this application can select efficient multiplicity even when the disk type is unknown, the disk type is not specified, or, furthermore, the multiplicity corresponding to the specified disk is not predetermined. In a second embodiment of the present invention, an example in which a disk array apparatus actively selects an efficient multiplicity will be described. The apparatus configuration, execution example, process flow, and effects will be described in the order they appear in this sentence.

Configuration of Disk Array Apparatus (Second Embodiment)

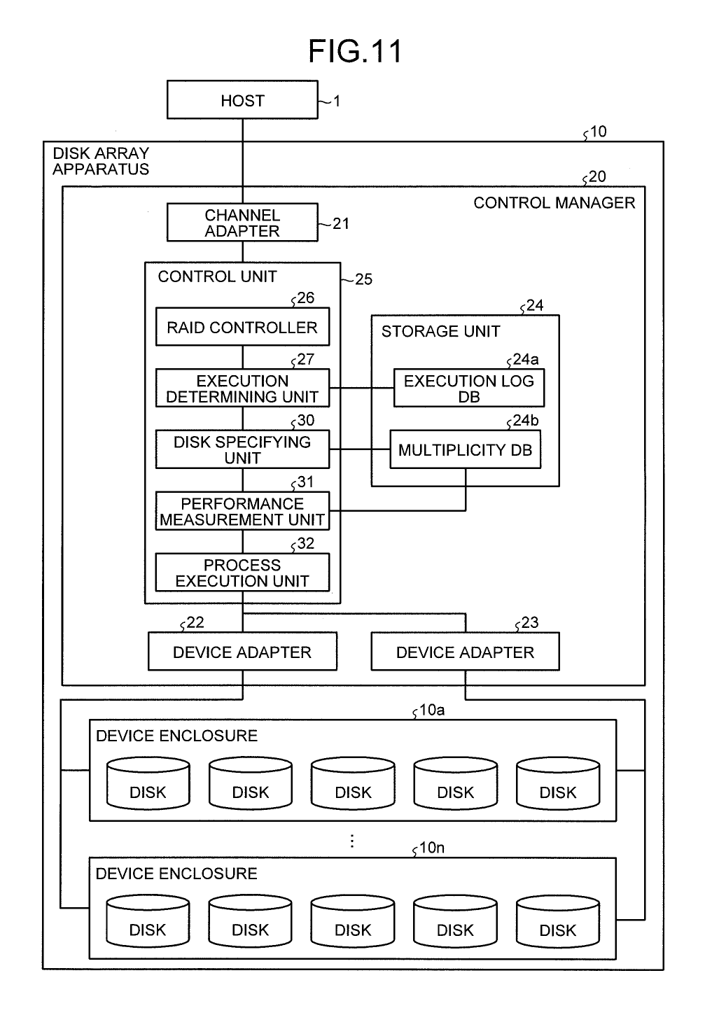

FIG. 11 is a block diagram of a configuration of a disk array system including a disk array apparatus according to the second embodiment. As illustrated in FIG. 11 and, in the disk array system, the host 1 and the disk array apparatus 10 are connected so as to be communicable with each other using a fibre channel (FC) or an iSCSI as they are in the first embodiment. The host 1 is a server device that stores data in the disk array apparatus 10 or reads data from the disk array apparatus 10.

The disk array apparatus 10 includes the device enclosures 10a to 10n and the controller module 20 as is included in the first embodiment. Each of the device enclosures 10a to 10n has the same function as that of the first embodiment and thus detailed description thereof will be omitted below.

The controller module 20 is a processing unit that performs data control on the device enclosures 10a to 10n. The controller module 20 includes the channel adapter 21, the device adapter 22, the device adapter 23, the storage unit 24, and the controller 25. Because the channel adapter 21, the device adapter 22, the device adapter 23, the storage unit 24, and the RAID controller 26 and the execution determining unit 27 of the controller 25 have functions the same as those of the first embodiment, detailed description thereof will be omitted. A disk specifying unit 30, a performance measurement unit 31, and a process execution unit 32 of the controller 25 having functions different from those of the first embodiment will be described here.

When the execution determining unit 27 determines that no process other then a sequential process is executed in a predetermined period, the disk specifying unit 30 specifies the disk type. For example, upon receiving a notification that no process other than the sequential process is executed from the execution determining unit 27, the disk specifying unit 28 acquires various types of information from disks having a volume to which a format process or a rebuild process is to be executed.

For example, the disk specifying unit 30 acquires the “CATEGORY, ROTATION RATE, TRANSFER RATE, AND CAPACITY” of disks to be processed from the information stored in the CM (cartridge memory) of a disk and disk information created by the manager. When the disk specifying unit 30 cannot acquire the information on the disks to be processed from the CM or the disk information, the disk specifying unit 30 outputs a performance measurement instruction to the performance measurement unit 31.

When the disk specifying unit 30 can acquire the “CATEGORY, ROTATION RATE, TRANSFER RATE, AND CAPACITY” representing the disk type, the disk specifying unit 30 specifies the multiplicity corresponding to the acquired “CATEGORY, ROTATION RATE, TRANSFER RATE, AND CAPACITY” from the multiplicity DB 24b. When the multiplicity corresponding to the acquired disk type is not stored in the multiplicity DB 24b, i.e., when the multiplicity cannot be specified, the disk specifying unit 30 outputs a performance measurement instruction to the performance measurement unit 31. In contrast, when the multiplicity corresponding to the acquired disk type is stored in the multiplicity DB 24b, i.e., when the multiplicity can be specified, the disk specifying unit 30 outputs the specified multiplicity to the process execution unit 32. The process execution unit 32 executes the sequential process with the multiplicity received from the disk specifying unit 30.

When the disk specifying unit 30 cannot determine the multiplicity, the performance measurement unit 31 changes the multiplicity to each multiplicity that can be assumed with respect to each given capacity of volume, executes the sequential process, and then measures the capacity per unit of time for which the process can be executed with each multiplicity. For example, when the performance measurement unit 31 receives a performance measurement instruction from the disk specifying unit 30, the performance measurement unit 31 executes the process on the disks having the volume to be processed by each three sets of data and with each of the single multiplicity, the double multiplicity, and the triple multiplicity. In other words, the performance measurement unit 31 formats each three sets of data with single multiplicity, double multiplicity, and triple multiplicity. Specifically, the performance measurement unit 31 formats three sets of data with single multiplicity, formats 3+3 data with double multiplicity, and formats 3+3+3 data with triple multiplicity. The performance measurement unit 31 measures the process capacity for which the process can be executed per unit of time in each multiplicity and outputs the measurement result to the process execution unit 32.

In the example represented here, the performance measurement unit 31 executes the process on each three sets of data to evaluate the performance, but the present invention is not limited to this. For example, the range in which the process is executed to evaluate the performance can be arbitrarily set and changed to, for example, every three blocks.

The process execution unit 32 executes a sequential process in a multiplicity with which the process capacity for which the process can be executed per unit of time is largest among those in each multiplicity that are measured by the performance measurement unit 31. In the above-described example, the process execution unit 32 executes the sequential process in the multiplicity with which the process capacity for which the process can be executed per unit of time is largest among those for which the process is executed by each three sets of data with single multiplicity, double multiplicity, and triple multiplicity.

Example of Execution by Process Execution Unit (Second Embodiment)

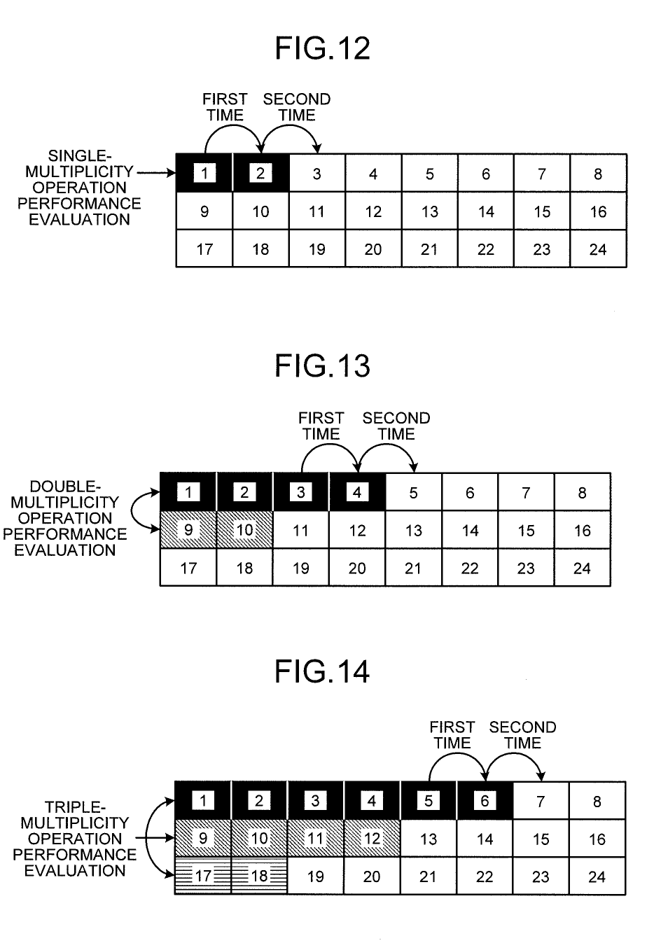

Specific examples of the performance measurement process executed by the performance measurement unit 31 will be described using FIGS. 12 to 14. FIG. 12 is a diagram of an example of evaluating the performance in single multiplicity, FIG. 13 is a diagram of an example of evaluating the performance in double multiplicity, and FIG. 14 is a diagram of an example of evaluating the performance in triple multiplicity.

The configuration of the volume to be processed is the same as that in FIG. 4. A case will be described in which the performance measurement is executed by each two sets of data. Specifically, the volume consists of data 1 to 24. The numerals 1 to 24 denote data and the order of sequential accesses. In other words, the sequential accesses to the volume are executed from 1. This illustration is just an example and the present invention is not limited to this.

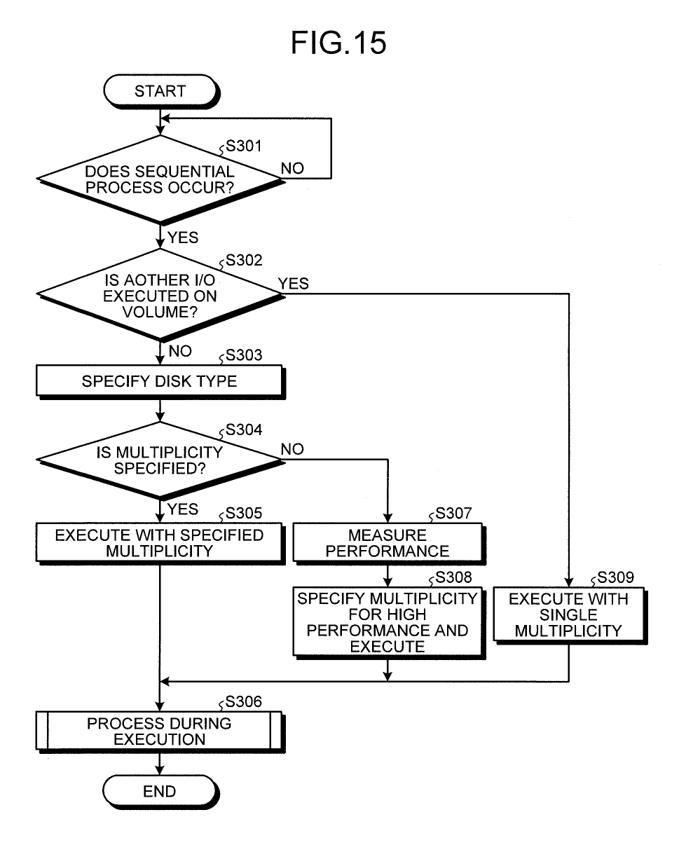

In this case, first, as illustrated in FIG. 13, the performance measurement unit 31 executes the process on the data “1, 2” with single multiplicity and measures the process capacity per unit of time. As illustrated in FIG. 14, the performance measurement unit 31 then executes the process on data “3, 4” and “9, 10” with double multiplicity and measures the process capacity per unit of time. As illustrated in FIG. 15, the performance measurement unit 31 then executes the process on data “5, 6”, “11, 12”, and “17, 18” with triple multiplicity and measures the process capacity per unit of time.

Thereafter, for example, when the process execution unit 32 determines that the process capacity is largest in the single multiplicity, the following processes are executed with single multiplicity in the order of “7, 8, 13, 14, 15, 16, 19, 20, 21, 22, 23, and 24”. When the process execution unit 32 determines that the process capacity is largest in the double multiplicity, the following processes are executed with double multiplicity in the order of, for example, “7, 8”, “13, 14”, and “15, 16” and “19, 20”, “21, 22”, and “23, 24”. When the process execution unit 32 determines that the process capacity is largest in the triple multiplicity, the following processes are executed with triple multiplicity in the order of, for example, “7, 8”, “13, 14”, and “19, 20”.

Process Flow (Second Embodiment)

The process flow of the disk array apparatus according to the second embodiment will be described using FIG. 15. FIG. 15 is a flowchart of a process flow upon execution of the sequential process.

As illustrated in FIG. 15, the execution determining unit 27 of the disk array apparatus 10 accepts an instruction for starting a sequential process on a volume in disks constituting the RAID (YES at step S301). The execution determining unit 27 refers to the execution log DB 24a and determines whether a process other than the sequential process is executed on the volume to be processed in a predetermined period (step S302).

When the execution determining unit 27 determines that no process other than the sequential process is executed in the predetermined period (NO at step S302), the disk specifying unit 30 specifies the disk type (step S303). Subsequently, the disk specifying unit 30 determines the multiplicity corresponding to the specified disk type from the multiplicity DB 24b (step S304).

When the disk specifying unit 30 specifies the multiplicity (YES at step S304), the process execution unit 29 executes the sequential process in the specified multiplicity (step S305). The disk array apparatus 10 then executes the process during the execution illustrated in FIG. 10 (step S306).

In contrast, when the disk specifying unit 30 cannot specify the multiplicity corresponding to the specified disk type from the multiplicity DB 24b (NO at step S304), the disk specifying unit 30 outputs a performance measurement instruction to the performance measurement unit 31. The performance measurement unit 31 then changes the multiplicity to each multiplicity that can be assumed with respect to each given capacity of volume, executes the sequential process, and then measures the process capacity per unit of time for which the process can be executed with each multiplicity (step S307). Even when the disk specifying unit 30 cannot acquire the disk type, the processes at NO (step S304) and the following steps are executed.

Thereafter, the process execution unit 32 executes the sequential process with the multiplicity in which the process capacity for which the process can be executed per unit of time is largest among those in each multiplicity that are measured by the performance measurement unit 31 (step S308). Thereafter, the disk array apparatus 10 executes the process during execution in FIG. 10 (step S306).

When the process execution unit 29 receives a notification that a process other than the sequential process is executed in the predetermined period from the execution determining unit 27 (YES at step S302), the process execution unit 29 executes the sequential process with single multiplicity (step S309). The disk array apparatus 10 then executes the process during execution, as in FIG. 10 (step S306).

Effects of Second Embodiment

According to the second embodiment, an efficient multiplicity can be selected even if the disk type is unknown, even if the disk type cannot be specified, or even if a multiplicity corresponding to a specified disk type is not predetermined.

Even if there are various disk types, by comparing multiplicity performance by actual measurement, a format process or a rebuild process can be executed with a multiplicity in which the maximum performance can be achieved. Furthermore, even if a new disk type is installed, a format process or a rebuild process can be executed with a multiplicity in which the maximum performance can be achieved without a new firmware change or device setting change.

[c] Third Embodiment

The embodiments of the present invention are described above. The present invention may be carried out in various different modes in addition to the above-described embodiments. Different embodiments will be described below.

Multiplicity

In the first and second embodiments, examples in which the process is executed with single multiplicity, double multiplicity, or triple multiplicity are described, but the present invention is not limited to these and arbitrary multiplicity can be used. For example, single to quintuple multiplicities may be used. Alternatively, single, triple, and quintuple multiplicities may be used.

Performance Measurement During Execution of Sequential Process

For example, the performance measurement unit 31 keeps measuring the process capacity per unit of time while executing the sequential process with multiplicity, which is determined by the process execution unit 32, and determines whether the process capacity becomes equal to or less than a predetermined value. When the process capacity is equal to or less than the predetermined value, the performance measurement unit 31 changes the multiplicity to single, double, or triple multiplicity, executes the sequential process by each predetermined capacity of volume, and then measures the process capacity per unit of time for which the process can be executed with each multiplicity. Thereafter, the process execution unit 32 can execute the sequential process with a multiplicity in which the process capacity can be executed per unit of time is largest among those processed in the respective multiplicities that are measured by the performance measurement unit 31. As a result, the sequential process can be executed with an appropriate multiplicity according to the load of the disks in execution.

System

Among the above-described processes according to the embodiments, the processes that are described as those automatically performed may be manually performed entirely or partially. Alternatively, the processes that are described as those performed manually may be automatically performed entirely or partially using a well-known method. The process procedures, control procedures, and specific names, which are illustrated in the specification and the drawings, and information including the various types of data and parameters in, for example, FIG. 2 may be changed arbitrarily unless otherwise noted.

The elements of each device illustrated in the drawings do not need to be physically configured as illustrated in the drawings. In other words, the specific modes of separation or integration of devices are not limited to those illustrated in the drawings. For example, the elements may be configured in a way that they are entirely or partially separated or integrated functionally or physically per arbitrary unit in accordance with various loads or how they are used. In addition, each process function to be performed by each device can be entirely or arbitrarily partly implemented by a CPU and programs analyzed and executed by the CPU.

Program

The disk array control methods described in the embodiments can be realized by executing prepared programs using a computer, such as a personal computer or a work station. The program can be distributed via a network, such as the Internet. The program may be recorded in a computer-readable recording medium, such as a hard disk, a flexible disk (FD), a CD-ROM, an MO, and a DVD, may be read from the recording medium, and thus executed by the computer.

According to an aspect of the disk array apparatus and the disk array control method that are disclosed by this application, the effects can be achieved in which a sequential process can be executed efficiently.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A disk array apparatus comprising:
an execution determining unit that, when a sequential process is executed on a volume of disks, determines whether a process other than the sequential process is executed in a predetermined period;
a disk specifying unit that specifies a disk type of the disks when the execution determining unit determines that no process other than the sequential process is executed in the predetermined period; and
a process execution unit that determines a multiplicity of the sequential process according to the disk type which is specified by the disk specifying unit, and executes the sequential process with the determined multiplicity.

2. The disk array apparatus according to claim 1, further comprising a first measurement unit that, when the multiplicity cannot be determined according to the disk type specified by the disk specifying unit, changes the multiplicity to multiplicity that is assumed with respect to a given capacity of volume, executes the sequential process, and measures a process capacity per unit of time for which the process is executed with the changed multiplicity,
wherein the process execution unit executes the sequential process with a multiplicity in which the process capacity per unit of time is largest among those measured by the first performance measurement unit.

3. The disk array apparatus according to claim 1, further comprising a second measurement unit that, when the process volume per unit of time becomes equal to or less than a predetermined value while the sequential process is being executed with the multiplicity determined by the process execution unit, changes the multiplicity to a multiplicity that is assumed with respect to a given capacity of volume, executes the sequential process, and measures a process capacity per unit of time for which the process can be executed with each multiplicity,
wherein the process execution unit executes the sequential process with a multiplicity in which the process capacity per unit of time is largest among those measured by the second performance measurement unit.

4. The disk array apparatus according to claim 1, wherein, when the execution determination unit determines that a process other than the sequential process is executed in the predetermined period, the process execution unit executes the sequential process with single multiplicity.

5. The disk array apparatus according to claim 1, wherein, when a process other than the sequential process is executed while the sequential process is executed with the determined multiplicity, the process execution unit changes the multiplicity to the single multiplicity and executes the sequential process with the single multiplicity.

6. The disk array apparatus according to claim 5, wherein, when the process other than the sequential process ends in a state in which the multiplicity is changed to the single multiplicity, the process execution unit changes the multiplicity to the determined multiplicity and executes the sequential process with the changed multiplicity.

7. A disk array control method, comprising:
determining whether a process other than the sequential process is executed in a predetermined period when a sequential process is executed on a volume of disks;
specifying a disk type of the disks when it is determined that no process other than the sequential process is executed in the predetermined period;
determining a multiplicity of the sequential process according to the specified disk type; and
executing the sequential process with the determined multiplicity.
